(19) United States
(12) Patent Application Publication
(10) Pub. No.: US 2004/0011726 A1
(43) Pub. Date: Jan. 22, 2004

(54) Filter part for fluid pipes

(76) Inventors: Erwin Weh, Illertissen (DE); Wolfgang Weh, Illertissen (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/312,946

(22) PCT Filed: Jun. 27, 2001
(86) PCT No.: PCT/EP01/07350

(30) Foreign Application Priority Data
Jun. 27, 2000 (DE) 200 10 933.2

(51) Int. Cl. B01D 29/00

(52) U.S. Cl. 210/352; 210/449

(57) ABSTRACT

The aim of the invention is to create a simple and load-resistant filter part for fluid pipes, especially for use with filling nipples, comprising a base body (3) and at least one fluid passage opening (2) which is covered by a filter element (4). According to the invention, the filter element (4) consists of a tightly wound spring wire (5) whose winding end (5c) is preferably supported on a collar ring (3b) on the foot (1b) of the filter.

The invention relates to a filter part for fluid pipes, especially for insertion in filling nipples, comprising a base body and at least one fluid passage opening which is covered by a filter element.

Such filter parts for fluid pipes are used widely in piping construction, especially for filtering out foreign bodies and dirt particles. Such filter parts are frequently provided with a sleeve-like shape in which several pass-through openings are provided. Said breakthroughs are generally covered by a filter element which is arranged as a fabric or as a metal braiding. Perforated plates or sintered bodies with a defined porosity are also frequently used as filter elements, especially in the fields of pneumatics and hydraulics. Such filter elements, and in particular metal fabrics or braidings, show certain irregularities in the mesh width, however. Furthermore, such filter elements are frequently sensitive to pressure jolts or changing loads, which may lead to material fatigue. Especially in the case of filling nipples for refueling natural gas into vehicles there are adverse conditions because in such cases the filter part is subjected to considerable strains at a filling pressure of 200 bars.

The invention is therefore based on the object of providing a simple and sturdy filter part for fluid pipes which in addition can be produced very cost-effectively and with variable rates of passage.

This object is achieved by a filter part for fluid lines according to the features of claim 1. Preferred embodiments are the subject matter of the subclaims.

By producing the filter element from narrowly wound spring wire it is possible to avoid laborious production methods such as the punching of the small pass-through openings or the production of the braiding. Contrary to this, the filter element can be produced by a simple winding process with high precision. An especially advantageous aspect is that the preliminary tension of the winding of the spring wire is variable, so that the rate of passage of the filter element can be adjusted during production to the respective purpose in a simple manner. By arranging the filter element as a spring, a high stability is further obtained, so that this filter part can also be used in high-pressure lines, and especially in filling nipples for refueling with natural gas. A particularly high stability is obtained in this respect by a conical or conoidal outside shape, with the winding end being capable of resting over a wide area on a circular collar ring at the filter end in order to withstand the high pressure load.

In a preferred embodiment the individual windings of the spring wire can engage in respectively arranged grooves of the base body, thus leading to a precise fixing of the individual windings. In this way the pass-through gaps between the closely adjacent windings are defined in a precise fashion, thus allowing a high evenness of the rate of the filter passage to be achieved. In a preferred embodiment, the winding tension of the spring wire can also be adjustable after the production, e.g. by twisting the filter head relative to the filter foot. When twisting in the direction of the winding one obtains a slight reduction in the diameter, so that the individual windings rest more closely on each other. This reduces the pass-through cross section of the filter element. Contrarily, namely by twisting opposite of the direction of winding, it is possible to slightly increase the pass-through cross section between the individual windings, thus obtaining an increase in the rate of passage. This procedure may also be appropriate for cleaning the filter element, because in this way dirt and deposits in the filter element are thrown off.

The secure fixing and support of the filter element on the filter part is preferably obtained by fixing the winding end of the spring wire to the collar ring of the base body. In this way the filter element is supported in a secure fashion over a wide surface area on the circular collar ring, so that even in the case of high pressures in the fluid line a precise bearing is obtained. In order to optimize the flow conditions, the tip or the filter head of the filter part can be rounded off. In this way the generation of noises during the fluid passage is substantially prevented.

The invention is now explained in closer detail by reference to an embodiment shown in the enclosed drawing, wherein:

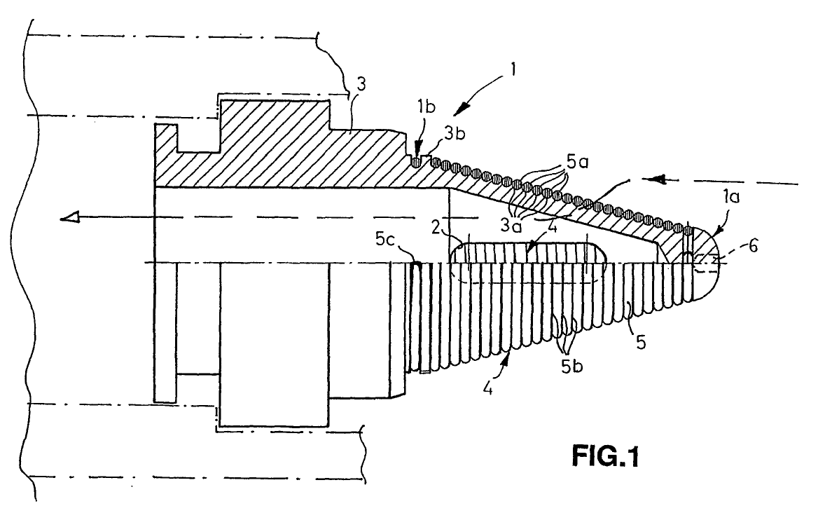

FIG. 1 shows a semi-longitudinal sectional view through a filter part for fluid pipes.

In the (only) FIG. 1 a filter part 1 is shown which comprises at least one fluid passage opening 2 in a base body 3 which is inserted in a filling nipple shown in the dot-dash line. Generally, several such passage openings 2 are provided, especially evenly distributed over the circumference. The fluid passage openings 2 are covered in this case by a filter element 4 which consists of a tightly wound spring wire 5. Said spring as the filter element 4 comprises a plurality of narrowly adjacent windings 5a which form pass-through gaps 5b which extend in a substantially radial fashion. The fluid passage is indicated here in broken lines.

As is shown, the filter element 4 substantially comprises a conical or conoidal external shape. The windings 5a of the spring wire 5 are shown to be engaging in correspondingly arranged grooves 3a of the base body, thus producing a precise fixing of the spring. The evenness of the pass-through gap 5b is thus increased.

The winding ends 5c are held once on the filter foot 1b and once on the filter head 1a. A circular collar ring 3b is provided on the base body 3 for the filter foot 1b, as a result of which the larger winding end 5c of the spring wire is fixed in a precise fashion and is supported over a wide surface area in order to withstand the high axial pressures and to prevent any loosening or widening of the filter element 4 relative to the base body 3.

A twister profile 6, e.g. a hexagon socket thread, can be provided on the filter head 1a which is preferably provided with a rounded-off arrangement for flow reasons, which twister profile can be used to twist the filter head 1a relative to the base body 3 in a limited fashion. In this way the windings 5a of the spring wire 5 are placed closer to each other or further apart, depending on the direction of twisting. When twisting against the direction of winding with an ascent of a number of angular degrees (cf. the ascent shown in the sectional view of the spring wire 5 over the fluid passage opening 2) the distance between the windings 5a is slightly increased, thus leading to a higher rate of passage. This is especially advantageous for cleaning purposes.

The spring wire 5 of the filter element 4 is preferably made of stainless steel, and especially austenitic steel, because in this way it is possible to achieve a high resistance against corrosion and a high temperature stability. This steel can be wound relatively easily with a high amount of dimensional stability, so that in this way the evenness of the pass-through gap 5b and the support of the winding end 5c on the collar ring 3b can be maintained with a high amount of repetitive precision. The same applies to high-quality spring steel.

1. A filter part for fluid pipes, especially for insertion in filling nipples, comprising a base body (3) and at least one fluid passage opening (2) which is covered by a filter element (4), characterized in that the filter element (4) consists of a narrowly wound spring wire (5).

2. A filter part as claimed in claim 1, characterized in that the filter element (4) has a conical outside shape.

3. A filter part as claimed in claim 1 or 2, characterized in that the windings (5a) of the spring wire (5) are arranged as to engage in grooves (3a) of the base body (3).

4. A filter part as claimed in one of the claims 1 to 3, characterized in that the winding pretension of the spring wire (5) is variable.

5. A filter part as claimed in claim 4, characterized in that the winding pretension of the spring wire (5) is adjustable.

6. A filter part as claimed in claim 5, characterized in that the winding pretension is adjustable with a twister profile (6) on the filter head (1a).

7. A filter part as claimed in one of the claims 1 to 6, characterized in that a collar ring (3b) is provided at the filter foot (1b) on which one winding end (5c) of the spring wire (5) is supported in the axial direction.

8. A filter part as claimed in one of the claims 1 to 7, characterized in that the spring wire (5) consists of stainless, austenitic steel.

9. A filter part as claimed in one of the claims 1 to 8, characterized in that the fluid passage is directed from the outside to the inside.

10. A filter part as claimed in one of the claims 2 to 9, characterized in that the tip or the filter head (1a) of the filter part (1) is rounded off.
